(19) United States
(12) Patent Application Publication
(10) Pub. No.: US 2017/0266808 A1
(43) Pub. Date: Sep. 21, 2017

(54) HANDLING DEVICE FOR OPENING A FLAP, AND CORRESPONDING METHOD

(71) Applicant: Dürr Systems AG, Bietigheim-Bissingen (DE)

(72) Inventors: Gerhard Alonso, Bönnigheim (DE); Sven Bitzer, Stuttgart (DE); Matthias Imle, Pleidelsheim (DE); Stefanie Lippisch, Ingersheim (DE); Siegfried Poppe, Markgröningen-Unterriexingen (DE)

(21) Appl. No.: 15/532,122

(22) PCT Filed: Dec. 2, 2015
(86) PCT No.: PCT/EP2015/002419

§ 371 Date: Jun. 1, 2017

(30) Foreign Application Priority Data
Dec. 3, 2014 (DE) 10 2014 017 855.2

(51) Int. Cl. B25J 9/16; B25J 19/02; B05B 13/02; B25J 15/00

(52) U.S. Cl. CPC B25J 9/1612; B25J 15/0047; B25J 19/026; B25J 19/027; B05B 13/0292; B05B 13/0221; B05B 13/0452

(57) ABSTRACT

A handling device is provided for opening a flap portion of a component part to be coated, in particular for opening a door or hood of a motor-vehicle body component part in a painting installation. The handling device includes a handling robot with a robot arm and a gripper mounted on the robot arm. The gripper is configured for engaging an engagement region or grip region on the flap to be opened, to enable the handling robot to open the flap with the gripper. The handling device further includes a sensor for non-contact sensing of the position of the gripper relative to the flap, to enable the gripper to be positioned relative to the engagement region on the flap. The sensor measures the distance from the handling device to the outside of the flap to be opened.

### CROSS-REFERENCE TO RELATED APPLICATIONS

This application is a national stage of, and claims priority to, Patent Cooperation Treaty Application No. PCT/EP2015/002419, filed on Dec. 2, 2015, which application claims priority to German Application No. DE 10 2014 017 855.2, filed on Dec. 3, 2014, which applications are hereby incorporated herein by reference in their entireties.

### BACKGROUND

The present disclosure relates to a handling device for opening or otherwise manipulating a flap portion of a component part to be coated, in particular for opening a door or hood of a motor-vehicle body component part in a painting installation. Furthermore, the present disclosure comprises a corresponding handling method.

In modern painting systems for painting motor-vehicle body component parts, the doors and hoods of the motor-vehicle bodies to be painted have to be opened during the painting process, so that a painting robot can paint the interior of the motor-vehicle body and the inside of the doors or hoods.

Handling robots, also referred to as door openers, or hood openers, are normally used for this purpose. Such robots may have, e.g., a pin to engage the door or hood to be opened, and can then open or close the flap (door or hood). In the case of a door of a motor-vehicle body, for example, the pin of the handling robot may be configured to engage the window gap, from which the side window pane is displaceable in the fully assembled state.

Precise positioning of the pin of the handling robot in the engagement region is currently difficult. This is because the known geometric data of the motor-vehicle body to be painted, in combination with the position of the motor-vehicle body on the conveyor, allow only a rough positioning of the pin of the handling robot relative to the engagement region on the flap (door or hood) that is to be opened.

JP 7-232110 discloses a handling robot that has a proximity sensor for facilitating the positioning of the handling robot relative to the door of a motor-vehicle body that is to be opened. In this case, the proximity sensor projects from the robot arm of the handling robot and, during operation, detects the inside of the door to be opened in a motor-vehicle body. Thus, the handling robot must first go into the interior of the motor-vehicle body, through the door opening for the side window. Next, the robot arm can then be lowered, whereupon the robot arm is then slowly drawn out again until the proximity sensor detects the inside of the door. At this point, a relative positioning between the pin of the handling robot, on the one hand, and the door to be opened, on the other hand, is then known. The handling robot can then raise the pin, move it slightly laterally and then insert it into the window gap, so that it can then open the door. A disadvantage of this known handling robot, therefore, is the relatively complex positioning of the handling robot relative to the door to be opened, since the handling robot must first move into the interior of the motor-vehicle body.

Known from EP 1 824 646 B1 is a completely different principle of positioning a handling robot relative to a door of a motor-vehicle body that is to be opened. In this case, a sensor is integrated into the pin of the handling robot that is used for opening, the measuring range of which sensor is directed downwards, and which generates a signal when the window gap of the door to be opened is passed. On the one hand, this requires that the pin used for opening first travel over the window gap, which makes the positioning complex. On the other hand, the structural integration of the sensor into the pin used for opening is difficult.

### SUMMARY

The present disclosure provides a handling robot for opening and closing the flap portion to be opened or manipulated (e.g. door, engine hood or trunk lid of a motor-vehicle body).

According to the principles of the present disclosure, for the purpose of positioning the handling robot, the distance between the outside of the flap portion to be opened and the handling robot is measured. The present disclosure thereby differs from the prior art, e.g., according to JP 7-232110, described at the outset, which provides for detection of the inside of the door to be opened. The positioning, according to the present disclosure, of the handling device relative to the flap portion to be opened is thus substantially simpler, since it is not necessary that the gripper (e.g. pin) used for opening be first moved into the interior of the motor-vehicle body.

In addition, the present disclosure also differs from the prior art according to EP 1 824 646 B1, described above, which provides that the sensor specifically detects the window gap, i.e. the engagement means for the gripper of the handling robot.

According to the principles of the present disclosure, the handling robot is, in some implementations, a freely programmable, multi-axis robot having serial kinematics. For example, a so-called Scara robot (Scara: selective compliance assembly robot arm) may be used for this purpose. In another exemplary implementation of the present disclosure, the handling robot is a conventional articulated-arm robot.

The handling robot guides a gripper (e.g. pin) for engaging in an engagement region or grip region (e.g. the window gap of a door) on the flap portion to be opened, such that the handling robot can open the flap portion with the gripper. The gripper in this case is matched to the geometry of the flap portion to be opened, so that the gripper can engage the engagement region on the flap to be opened. In the case of opening a door of a motor-vehicle body, the gripper is, in some implementations, in the form of a pin, so that the gripper can engage in the window gap of the door.

In addition, the handling device according to the present disclosure comprises a sensor for non-contact sensing of the position of the gripper relative to the flap portion, to enable the gripper to be positioned relative to the engagement region on the flap portion.

According to the present disclosure, the sensor measures the distance to the outside of the flap to be opened. This is advantageous because the handling robot can then place the gripper in the engagement region from the outside, without the necessity of first moving the sensor into the interior of the motor-vehicle body.

In an exemplary implementation of the present disclosure, the sensor is mounted on or in the robot arm. As the gripper can break off in the event of a mechanical overload and then have to be replaced, the gripper can be designed according to the principles of the present disclosure as a simple component part, so that replacement of the gripper is inexpensive.

Furthermore, in such an implementation, the structural integration of the sensor into the robot arm is advantageous, because the sensor is less susceptible to soiling. In addition, the structural integration of the sensor into the robot arm is also advantageous because the outer contour of the handling robot is not thereby increased, such that the risk of collision also does not increase.

In an exemplary implementation of the present disclosure, the sensor has a measuring range that projects obliquely forward from the robot arm. This offers the advantage that, as the gripper approaches the door to be opened, the measuring range of the sensor always has the outside of the door to be opened “in view”.

In other implementations, e.g., if the sensor is mounted on the rotor base, the measuring range of the sensor projects straight (horizontally) forward.

In the case of the handling device according to the present disclosure, the gripper, in some implementations, projects transversely downward from the robot arm, so that it can engage in the engagement region on the flap to be opened. The gripper in this case may be connected to the robot arm via, e.g., a robot hand axis. Alternatively, however, it is also possible for the handling robot not to have any robot hand axis, such that the gripper is then mounted directly on the distal robot arm.

Furthermore, it should be mentioned that the sensor measures the distance to the outside of the flap to be opened (e.g. door, hood, trunk lid of a motor-vehicle body), in some implementations, as a quantity. The present disclosure thereby differs from, e.g., the prior art described in JP 7-232110, in which the sensor detects only an approach to the inside of the door to be opened and then outputs a qualitative signal at a certain distance. In contrast, in the present disclosure, the quantitative measurement of the distance to the outside of the flap to be opened makes it possible, on approaching the outside of the flap to be opened, to achieve a continuous position control, i.e. with a feedback of the measured distance to the outside of the flap to be opened.

Concerning the gripper, it should also be mentioned that the gripper, in some implementations, has a predetermined breaking point, such that the gripper breaks off in the event of a mechanical overload. The mechanical loading capacity of the predetermined breaking point is, in some implementations, designed such that the gripper breaks off before the mechanical loading capacity of the flap to be opened and/or of the handling robot is exceeded.

For example, the gripper may be made of plastic, e.g., to inhibit formation of scratch marks on the flap to be opened.

It should also be mentioned that the sensor is, in some implementations, connected to a sensor line, which runs, at least along a part of its length, inside the robot arm. In such an implementation, the sensor line is then protected and the outer contour of the handling robot is not increased.

It has already been mentioned above that the flap to be opened may be a door of a motor-vehicle body. In this case, the engagement region or grip region for the gripper of the handling robot is usually formed by a window gap in the door.

In other implementations, there is also the possibility that the engagement means on the flap to be opened is an aid that is removably attached to the flap. For example, such an aid may be attached to a trunk lid to be opened or to a hood, so that the gripper can grip the trunk lid or the hood. Thus, in some implementations of the present disclosure, the engagement region or grip region is a component that is detachably connected to the flap to be opened.

Furthermore, according to the principles of the present disclosure, the engagement region or grip region may be in the form of a license-plate recess, an opening for a headlamp, or similar vehicle body feature.

According to the principles of the present disclosure, it is also possible to check the contact of the gripper with the engagement means. This may be effected, for example, by evaluation of the sensor signal.

With regard to the design and the mode of operation of the sensor, there are various possibilities within the scope of the present disclosure. The sensor is, in some implementations, a distance sensor, for example an ultrasonic sensor or an inductive sensor. Other implementations may include other types of sensors according to the present disclosure. For example, a radar sensor may also be used.

The sensor, in some implementations, recognizes materials made of steel or aluminum. In such implementation, a signal corresponding to such a material is recognizable at least upon an approach to less than 100 mm (e.g. depending on the sensor and the location of the sensor, in the range of less than 50 to 500 mm).

It should also be mentioned that, in some implementations, only a single sensor is provided, to enable the gripper to be positioned in the engagement means on the flap to be opened.

Moreover, the present disclosure also includes a complete coating installation having at least one such handling device as described herein. For example, this may be a painting installation for painting motor-vehicle body components.

In addition, it should also be mentioned that the handling robot, in some implementations, may also provide collision control, so that, for example, a collision of the handling robot with a component part (e.g. motor-vehicle body component) or with the cabin walls of a painting cabin, is identified.

As part of this collision control, the torque, for example, which acts on the Z axis (vertical axis) of the handling robot, may be measured. Thus, this torque increases abruptly when the handling robot rotates about its Z axis (vertical axis) and then collides with a delimitation (e.g. motor-vehicle body component).

Alternatively, in some implementations, it is also possible, as part of the collision control, for the torque of all robot axes, or at least a plurality of robot axes, to be evaluated.

Finally, the present disclosure also encompasses a corresponding handling method, as already given by the above description, and, therefore, to the extent that it is repetitive, a separate description of the handling method is omitted.

In the handling method of the present disclosure, a rough positioning of the gripper is, in some implementations, effected first, and then a fine positioning of the gripper.

The rough positioning of the gripper relative to the flap to be opened may be based on the known geometrical data of the motor-vehicle body component part and the predetermined position of the motor-vehicle body component part. This is because, in this rough positioning, the relatively rough tolerances with respect to the geometric data and the position of the motor-vehicle body are not problematic.

In the present disclosure, the fine positioning of the gripper relative to the engagement means on the flap to be opened is effected with sensor data being taken into account.

Also according to the present disclosure, the handling method may effect parts control and collision control by monitoring the deflection (deformation) of the gripper. Thus, in a normal handling operation, the gripper undergoes deflection because of the mechanical load that occurs in that case, the deflection being within a certain angular range. Also, in the case of the gripper colliding with a delimitation (e.g. component, cabin wall), a mechanical load acts on the gripper, this resulting in a corresponding deflection of the gripper. In the case of a collision, however, the deflection of the gripper is greater than in the case of a normal handling operation. In contrast, without a physical contact between the gripper and the component to be handled or a delimitation, the gripper does not undergo any deflection at all. This makes it possible to distinguish the following three operating states in dependence on the deflection of the gripper:

no contact between the gripper and components or boundaries,

physical contact between the gripper and a component to be handled in the course of a normal handling operation, and

collision of the gripper with a delimitation (e.g. component part or cabin wall).

The deflection (deformation) of the gripper may be determined, for example, by strain gauges, which are known from the prior art and which therefore need not be described in greater detail.

### DRAWINGS

The present disclosure is explained in more detail below in the description present disclosure with reference to the figures, in which are shown:

FIG. 1A a cross-sectional view through a motor vehicle door during the approach of the handling robot to open the door,

FIG. 1B a modification of FIG. 1A, wherein a gripper of the handling robot is already located over the window gap of the door to be opened,

FIG. 1C a modification of FIGS. 1A and 1B, wherein the gripper of the handling robot has already gone into the window gap of the door,

FIG. 1D a modification of FIGS. 1A-1C, wherein the sensor is disposed on the robot base,

FIG. 2 the handling method according to the present disclosure, in the form of a flow diagram,

FIG. 3 the process of opening a vehicle door, as a flow diagram,

FIG. 4 the process of opening a vehicle door, with parts control,

FIG. 5A the process of opening a hood of a vehicle body, as a flow diagram, and

FIG. 5B a perspective view of an engine hood of a vehicle body, with a gripper.

### DESCRIPTION

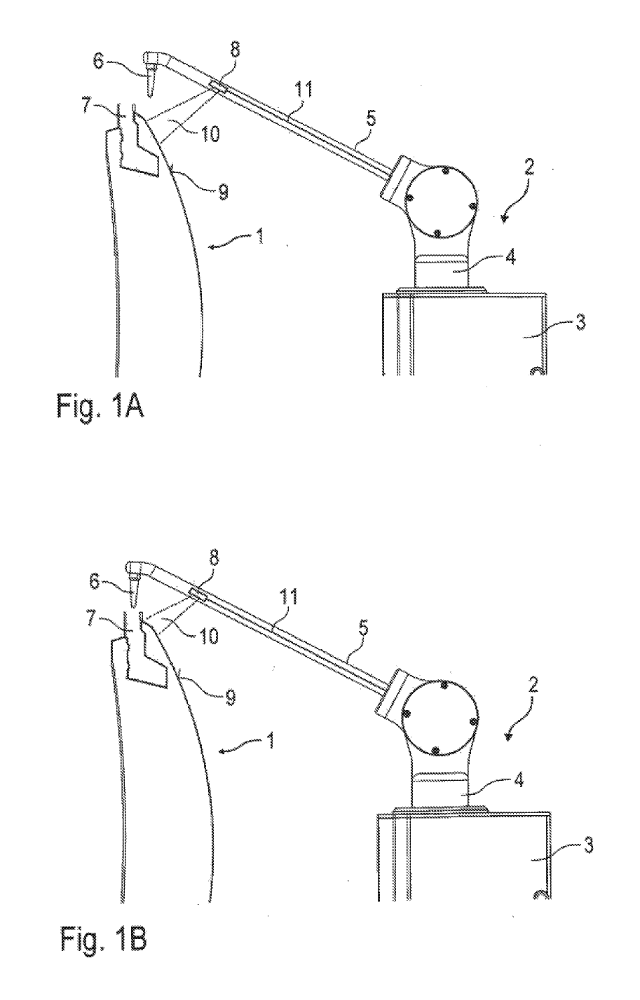

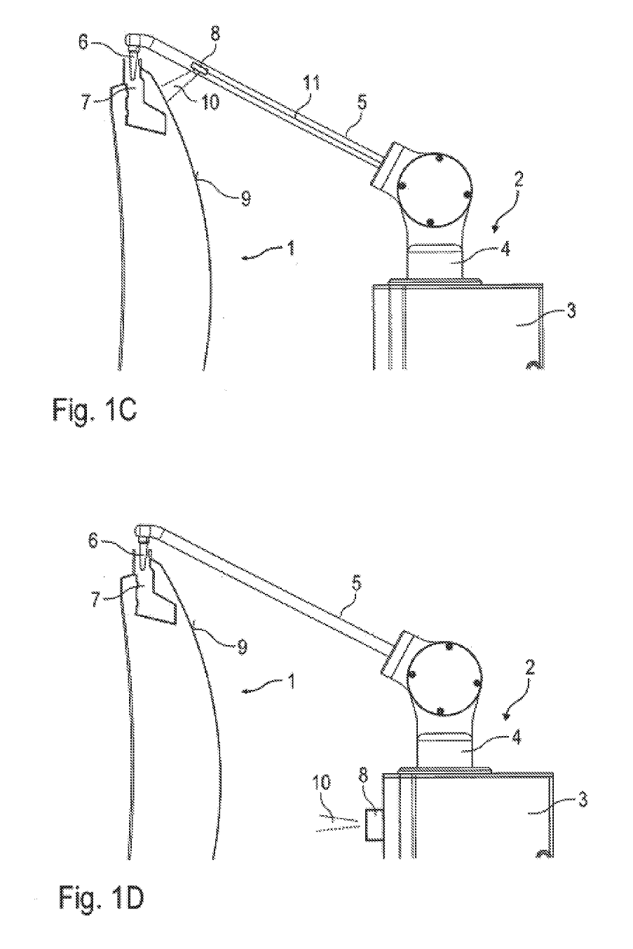

FIGS. 1A-1C show various operating states of a handling device according to the present disclosure for manipulating a flap portion in the form of a door 1 of a motor-vehicle body, so that a painting robot, not shown, can paint the interior of the motor-vehicle body and the inside of the door 1.

For this purpose, the handling device according to the present disclosure has a multi-axis handling robot 2 which, with its robot base 3, can optionally be disposed in a stationary manner or so as to be displaceable along the conveying direction of the motor vehicle bodies.

A robot member 4 is disposed on the robot base 3, the robot member 4 being rotatable, relative to the robot base 3, about a vertical axis of rotation.

A robot arm 5 is rotatably arranged on the rotatable robot member 4, the robot arm 5 being rotatable, relative to the robot member 4, about a horizontal axis of rotation. In the drawings, this axis of rotation is oriented at right angles to the plane of the drawing.

Mounted at the distal, free end of the robot arm 5, there is a gripper 6, which projects transversely downward from the robot arm 5, so that the gripper 6 can be articulated and inserted into an engagement region or grip region in the form of a window gap 7 of the door 1, as shown in FIG. 1C.

A distance sensor 8, which measures the distance to the outside 9 of the door 1 within a predetermined measuring range 10, is disposed in the robot arm 5. The measuring range 10 of the distance sensor 8 in this case projects obliquely forward and downward from the robot arm 5. As a result, as the gripper 6 approaches the window gap 7 in the door 1, the distance sensor 8 can measure the distance to the outside 9 of the door 1, and thus enables controlled fine positioning of the gripper 6 relative to the window gap 7.

The drawings additionally show a sensor line 11, which runs within the robot arm 5.

As the window gap 7 is approached, the gripper 6 is first positioned over the window gap 7, as represented in FIG. 1B.

Next, the gripper 6 is then lowered down into the window gap 7, as represented in FIG. 1C.

Finally, the handling robot 2 can then pull open the door 1.

FIG. 1D shows a modification of FIGS. 1A-1C, such that, in order to avoid repetitions, reference is made to the above description, the same references being used for details that correspond.

In this exemplary implementation, the distance sensor 8 is mounted on the robot base 3, and measures the distance to the outside of the door 1.

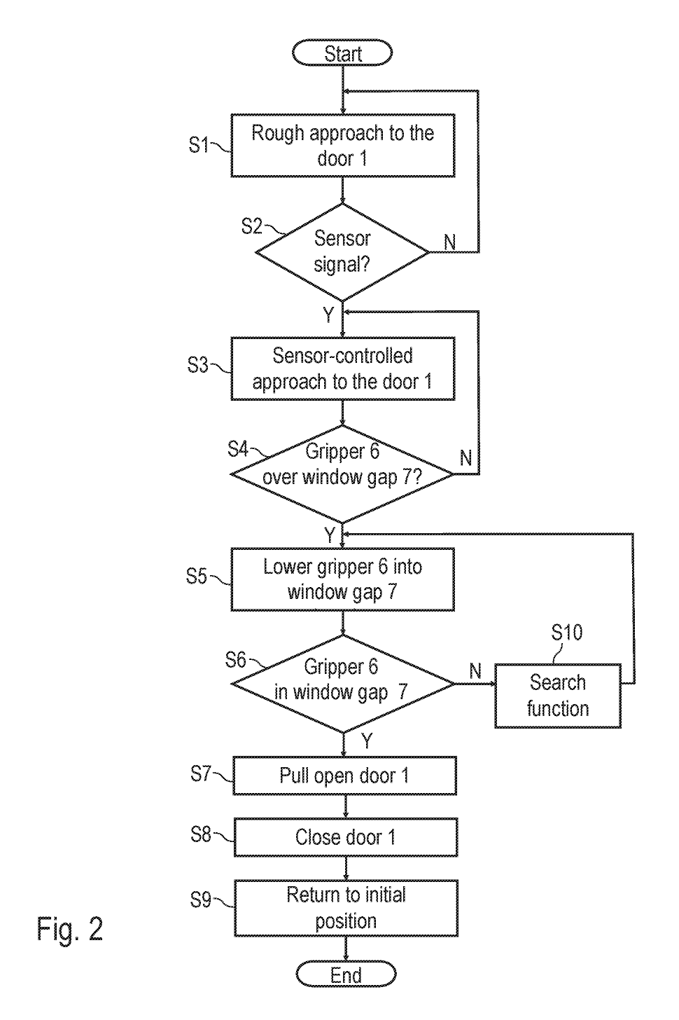

The flow diagram represented in FIG. 2 illustrates an exemplary handling method according to the present disclosure.

In a first step S1, the handling robot 2 is operated in a rough approach of the door 1 to be opened. In this rough approach, the sensor data of the distance sensor 8 need not yet be evaluated. Rather, the rough positioning can take place solely on the basis of the known geometric data of the motor-vehicle body and the likewise known position of the motor-vehicle body on the conveyor.

During this rough positioning, it is checked, in a step S2, whether the distance sensor 8 already senses a distance signal.

If this is the case, then, in a step S3, a sensor-controlled approach of the gripper 6 to the door 1 is effected, the signals measured by the distance sensor 8 being taken into account as part of a position control.

In a step S4, it is continuously checked in this case whether the gripper 6 is located above the window gap 7.

If this is the case, the gripper 6 is lowered down into the window gap 7, in a step S5.

Then, in a step S6, it is checked whether the gripper 6 is located in the window gap 7.

If this is not the case, a search function is activated in a loop, in a step S10.

Otherwise, the door 1 can then next be pulled open, in a further step S7.

In a step S8, the door 1 can then be closed again.

Finally, a return to the initial position is effected in a step S9.

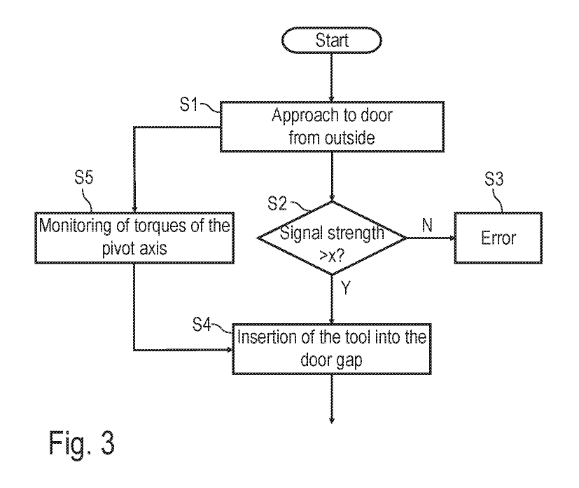

FIG. 3 shows, in the form of a flow diagram, a process, according to the present disclosure, of opening a door of a motor-vehicle body.

In a first step S1, the handling robot causes the gripper to approach the door from the outside. During this approach, the known body data of the motor-vehicle body, which represents the geometry of the motor-vehicle body, is taken into account.

During the approaching of the outside of the door of the motor-vehicle body, the signal strength of the sensor is measured and compared with a limit value x, in a step S2. If, despite the approach to the outside of the door, the signal strength does not exceed the limit value x, this indicates that the door is not at the stored location, such that, in a step S3, it is determined that there is an error. For example, an error flag may then be set.

Otherwise, the control system proceeds such that, in a step S4, the gripper can then be inserted in the engagement means (e.g. door gap) on the door, in order to open the door.

In this process, the torque, which acts in a vertical axis of rotation (“pivot axis”), is monitored in a step S5. On the one hand, this renders possible collision control, since this torque increases abruptly in the case of a collision. This torque monitoring also renders possible parts control, i.e. control of whether the part to be opened (e.g. door) is present, since the part then opposes the handling robot with a corresponding resistance.

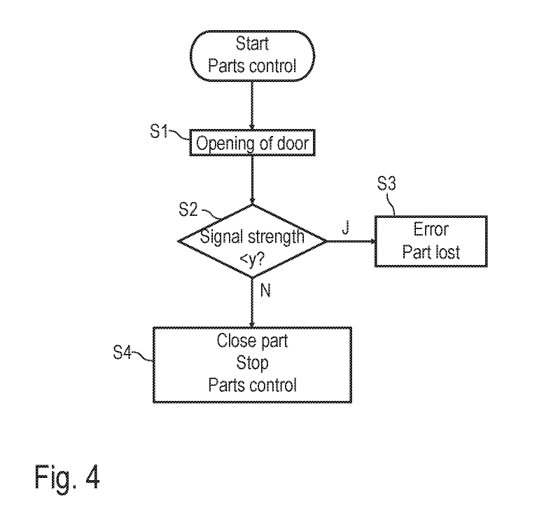

Such a parts control is shown in FIG. 4, in the form of a flow diagram.

In a first step S1, a door of a motor-vehicle body, for example, is opened.

In this case, in a step S2, the signal strength of the sensor is measured and compared with a limit value y.

If the signal strength is less than the limit value y, this indicates an error, since the sensor does not detect the door. This may be due to the fact, for example, that the contact between the gripper and the door to be opened has been lost. An error is then identified in a step S3, in which case, for example, an error flag may then be set.

Otherwise, in a further step S4, the normal process is continued, and the part (e.g. door) is then closed again.

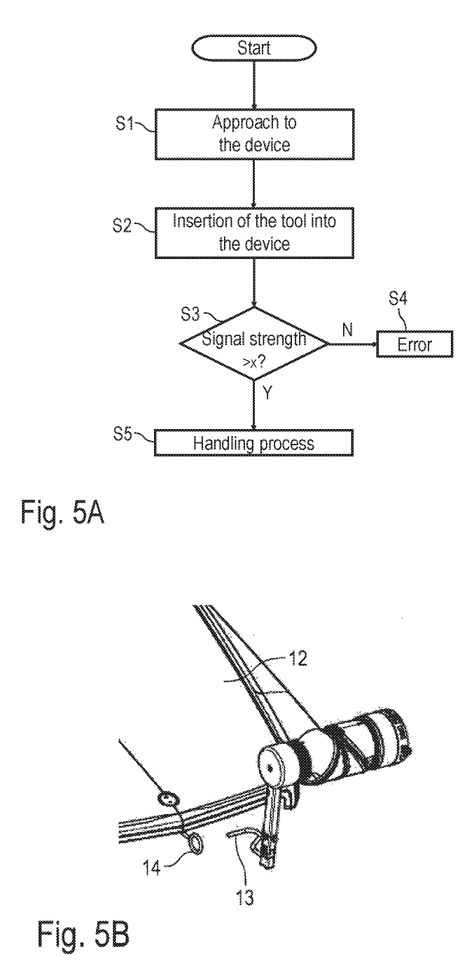

FIGS. 5A and 5B illustrate a process of opening an engine hood 12 of a motor-vehicle body by means of a gripper 13, which is moved by a handling robot in the manner described above.

For the purpose of opening the engine hood 12, the gripper 13 can engage in a ring 14 on the engine hood 12.

In a first step S1, in opening of the engine hood 12, the gripper 13 is then first moved towards the ring 14.

Next, in a further step S2, the gripper 13 is then moved into the ring 14.

In this case, in a step S3, the signal strength of the sensor is measured and compared with a limit value x.

If the measured signal strength does not exceed the limit value x, it is determined that the gripper 13 has not been inserted in the ring 14. In a step S4, an error is then identified, in which case, for example, an error flag may be set.

Otherwise, in a step S5, the normal handling process is effected, i.e. the engine hood 12 is opened in the usual manner and then closed again.

The present disclosure is not limited to the exemplary implementations described above. Rather, it should be understood that a plurality of variants and modifications are possible.

1.-16. (canceled)

17. A handling device for manipulating a flap portion of a component part to be coated, the handling device comprising:
a handling robot having a robot arm and a gripper, the gripper being mounted on the robot arm and configured to engage an engagement region on the flap portion of the component part, the handling robot configured to articulate the gripper to engage and open the flap portion; and
a non-contact position sensor configured to measure the distance to an outside surface of the flap portion of the component part.

18. The handling device according to claim 17, wherein the sensor is mounted to the robot arm.

19. The handling device according to claim 18, wherein the sensor is connected to a sensor line, wherein the sensor line runs, at least along a part of its length, inside the robot arm.

20. The handling device according to claim 18, wherein the sensor has a measuring range that projects obliquely forward from the robot arm.

21. The handling device according to claim 17, wherein the sensor is mounted on a robot base.

22. The handling device according to claim 17, wherein the sensor measures a quantity of distance to the outside surface of the flap portion.

23. The handling device according to claim 17, wherein the sensor is one of a distance sensor, an ultrasonic sensor, an inductive sensor, and a radar sensor.

24. The handling device according to claim 17, wherein the gripper projects transversely downward from the robot arm.

25. The handling device according to claim 17, wherein the gripper has a predetermined breaking point, and the predetermined breaking point is less than the mechanical loading capacity of each of the flap portion and the handling robot.

26. The handling device according to claim 17, wherein the flap portion is a door of a motor-vehicle body, and the engagement is a window gap in the door.

27. The handling device according to claim 17, wherein the engagement region is provided on a removable attachment to the flap portion.

28. A coating installation having a handling device according to claim 17.

29. A method for manipulating a flap portion of a component part to be coated, the method comprising:
positioning a gripper with a handling robot, relative to an engagement region on the flap portion;
during the positioning of the gripper, measuring the distance to an outside surface of the flap portion with a sensor;
engaging the flap portion and the gripper; and
articulate the gripper during engagement with the flap portion to move the flap portion relative to the component part.

30. The method according to claim 29, wherein the component part is a motor-vehicle body component part and the flap portion is a motor-vehicle door, the method further comprising:
positioning of the gripper relative to the door based on stored geometrical data of the motor-vehicle body component part and a predetermined position of the motor-vehicle body component part, the stored geometrical data and the predetermined position being independent of the distance measured by the sensor;
positioning of the gripper above the engagement region of the door based on the distance measured by the sensor;
lowering the gripper into engagement with the door at the engagement region; and
opening the door by drawing back the gripper.

31. The method according to claim 29, further comprising:
detecting a deformation of the gripper; and
identifying an engagement of the gripper with the flap portion based on the deformation.

32. The method according to claim 29, further comprising:
detecting a deformation of at least one structural member of the handling robot.

33. The method according to claim 32, further comprising:
identifying a collision of the at least one structural member of the handling robot with a delimitation based on the deformation.

34. The method according to claim 29, wherein the handling robot includes a robot arm with a vertical axis of rotation and the gripper is rotatable on the robot arm about the vertical axis of rotation, the method further comprising:
measuring a torque value acting about the vertical axis of rotation; and
comparing the torque value to at least one predefined limit value.

35. The method according to claim 34, further comprising:
identifying a status of at least one of the robot arm and the gripper based on the comparison based on the comparison, the status being one of a disengagement of the gripper and the flap portion, the engagement of the gripper and the flap portion, and a collision of the robot arm and a delimitation.

36. The method according to claim 35, wherein the delimination is one of the component part and a cabin wall.
